(19) United States
(12) Patent Application Publication
(10) Pub. No.: US 2016/0265419 A1
(43) Pub. Date: Sep. 15, 2016

(54) MOUNTING ASSEMBLY

(71) Applicant: Caterpillar Inc., Peoria, IL (US)

(72) Inventors: Nicolae C. Pelei, Lafayette, IN (US); Alexandru P. Nedelea, Lafayette, IN (US)

(73) Assignee: Caterpillar Inc., Peoria, IL (US)

(21) Appl. No.: 15/162,957

(22) Filed: May 24, 2016

(51) Int. Cl. F02B 29/04; F16F 15/08; F16M 13/02

(52) U.S. Cl. CPC F02B 29/045; F16M 13/02; F16F 15/08

(57) ABSTRACT

A mounting assembly for connecting an aftercooler to an engine system is provided. The mounting assembly has abase member, a support block, and an adjuster. The base member includes a first member and a second member having first through holes and second through holes respectively. The support block is adapted to be received into a central cavity of the base member. The adjuster is coupled with the first member and has a central channel for receiving a fastener. The support block has an isolation assembly that includes a sleeve element and an isolation member. A first surface of the sleeve element is adapted to be in contacting relationship with the adjuster at a first end of the base member, and a second surface of the sleeve element is adapted to be in a contacting relationship with a first surface of the base member at a second end of the base member.

### TECHNICAL FIELD

The present disclosure relates to mounting structures, and more specifically, to the mounting structure in association with an engine and an aftertreatment system.

### BACKGROUND

aftercooler (also known as an intercooler) is utilized in an engine for reducing the temperature of air compressed by a turbocharger. The turbocharger compresses the inlet air for combustion using a turbine driven by the exhaust gases of the engine. The compressed inlet air from the turbocharger is passed through the aftercooler for temperature reduction. Typically, the aftercooler is supported on the engine using a mounting assembly. Since, by design, the aftercooler is sensitive to vibrations, isolation from engine vibration is one of required characteristics of the mounting assembly. The mounting assembly is designed to reduce the transmission of vibrations to the aftercooler by the use of isolators that can be mechanical, hydraulic, and magnetic, among others. On mechanical isolators, a vibration dampening material is used mostly rubber or plastic-based materials.

Taking into consideration a size and location of the aftercooler relative to the engine, the best results have been achieved using multiple radial type isolators incorporated into the mounting assembly. These isolators consist from an inner and an outer sleeves, the space between them being filled with vibration dampening material. Using multiple radial isolators allow a better weight distribution of the aftercooler and better vibration dampening effect.

Conventionally, isolator spacers are clamped into a support structure which allows enough flex in it to result in a solid clamp column between a cooler bracket and the isolator spacer. A preload is a tension created in bolts during tightening and is required to be maintained to prevent loosening of the bolts. However, due to engine vibrations, the bolts may become loose and the isolator spacers develop a clearance into the support structure which in turn results in a detachment of aftercooler from the engine. This leads to machine downtime, shortened service life, and reliability issues, among others. Further, various other solutions, such as washers, adhesives, are also utilized for preventing the loosening of the bolts. However, such systems may be compromised due to weakening of the adhesive bonds or washer failure.

U.S. Pat. No. 3,180,594 describes an anti-vibration mounting. The anti-vibration mounting is adjusted to change the position of a supported body and the damping characteristics of the anti vibration mounting. A tubular spacer surrounding a core extending beyond the ends of the tubular spacer. A tubular adjusting sleeve surrounding a tubular carrier has an annular washer at both the ends. A resilient bushing surrounds the tubular spacer and is axially confined between the annular washers. The damping characteristics of the resilient bushing may be adjusted to adapt to vibration characteristics of the vibrating system by a number of nuts. The adjusting of the nuts compresses the resilient bushing as per the requirement.

However, known solutions may not be robust over longer durations, leading to increase in cost and system downtime. Therefore, there is a need for an improved mounting assembly provided in association with the aftercooler.

### SUMMARY OF THE DISCLOSURE

In one aspect of the present disclosure, a mounting assembly for connecting an aftercooler to an engine system is provided. The mounting assembly comprises a base member that includes a first member and a second member extending therefrom. The base member has a U shaped cross section. The base member includes a plurality of first through holes provided on the first member in a spaced apart arrangement along a first axis, The base member also includes a plurality of second through holes. The plurality of second through holes are provided on the second member in a spaced apart arrangement parallel to the first axis. Each of the plurality of first through holes is coaxial with the corresponding plurality of second through holes. The mounting assembly includes an adjuster. The adjuster is adapted to be received into each of the plurality of first through holes. The adjuster defines a central channel therethrough. The central channel of the adjuster is adapted to receive a fastener therein. The mounting assembly further includes a support block. The support block is adapted to be received into a central cavity defined by the base member. The support block includes a plurality of through holes. The plurality of through holes are provided in a spaced apart arrangement parallel to the first axis. Each of the plurality of through holes has an isolation assembly. The isolation assembly includes a sleeve element and an isolation member. The sleeve element is adapted to be in a surrounding contacting relationship with the fastener. The isolation member is in a surrounding contacting relationship with the sleeve element. Each of the plurality of through holes of the support block is coaxial with the corresponding plurality of first and second through holes of the base member respectively. Further, a first surface of the sleeve element of the support block is adapted to be in a contacting relationship with the adjuster at a first end of the base member. A second surface of the sleeve element of the support block is adapted to be in a contacting relationship with a first surface of the base member at a second end of the base member. The first end is opposite to the second end.

Other features and aspects of this disclosure will be apparent from the following description and the accompanying drawings.

### BRIEF DESCRIPTION OF THE DRAWINGS

FIG. 1 is a perspective view of an engine system with an aftercooler attached thereon, in accordance with the concepts of the present disclosure;

FIG. 2 is a perspective view of the engine system having a mounting assembly attached thereon, in accordance with the concepts of the present disclosure;

FIG. 3 is a perspective view of the mounting assembly having a support block, in accordance with the concepts of the present disclosure;

FIG. 4 is a sectional view of the mounting assembly along a section line 3-3′ as shown in FIG. 3, in accordance with the concepts of the present disclosure; and

FIG. 5 is a flowchart of a method for coupling an adjuster and a fastener to the mounting assembly, in accordance with the concepts of the present disclosure.

### DETAILED DESCRIPTION

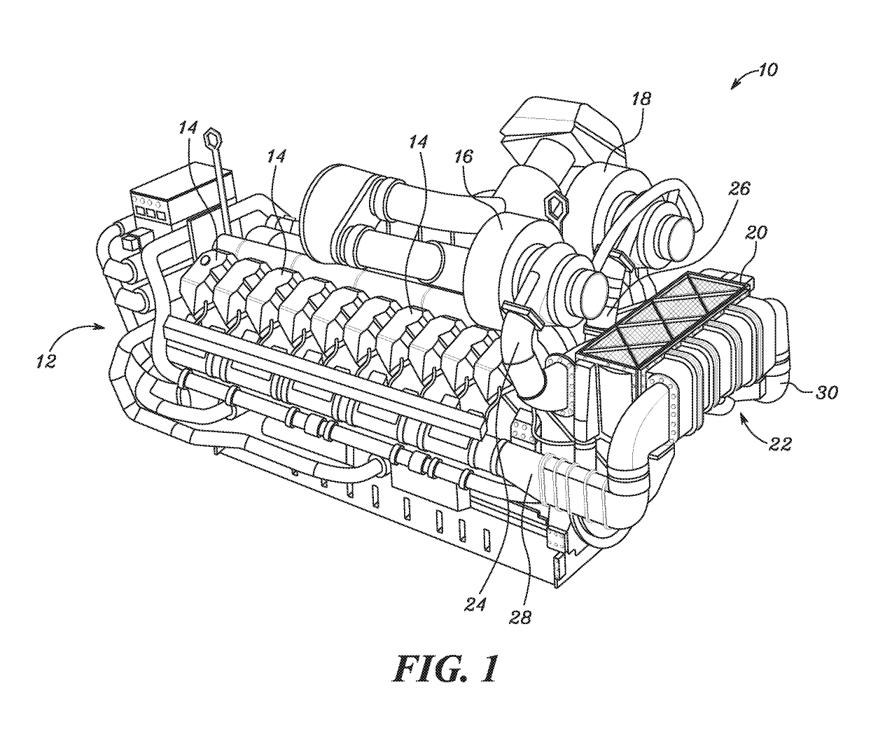

Referring to FIG. 1, an engine system 10 is illustrated. The engine system 10 includes an engine block 12, a number of cylinders 14, a first turbocharger 16, a second turbocharger 18, and an aftercooler 20. The first turbocharger 16 and the second turbocharger 18 are connected with the aftercooler 20 using a first conduit 24 and a second conduit 26.

The engine system 10 is a type of internal combustion engine which utilizes diesel cycle for power generation. The internal combustion engine utilizes four stroke cycles for power generation i.e. intake stroke, compression stroke, power stroke and exhaust stroke. The engine system 10 requires air during the intake stroke and pushes out exhaust gases after power stroke. The engine system 10 has a first intake manifold 28 and a second intake manifold 30 for delivery of air for combustion and exhaust manifold (not shown) to assist in pushing out the burnt gases after combustion. The exhaust gases flowing through the exhaust manifold of the engine system 10 may be used to drive turbines of the first turbocharger 16 and the second turbocharger 18 and compress intake air before combustion. Further, compression of intake air results in rise of temperature and also decrease in density, The decrease in density may be controlled as the compressed air passes through the aftercooler 20. Although the engine system 10 is described as the internal combustion engine herein, alternatively, the engine system 10 may include any other internal combustion engine, such as, a spark ignition engine, a compression ignition engine, a natural gas engine, among others to carry out principles of current disclosure without departing from the meaning and scope of the disclosure.

The aftercooler 20 is a type of heat exchanger which radiates excessive heat generated during compression of air by the first turbocharger 16 and the second turbocharger 18. The first conduit 24 and the second conduit 26 may deliver compressed air from the first turbocharger 16 and the second turbocharger 18 respectively to the aftercooler 20. The increase in density of the compressed air results in efficient combustion and reduction in emissions. The engine system 10 may have configuration variation in terms of number of cylinders 14 and the placement of the cylinders 14 relative to each other. The engine system 10 may include various other components, ouch us cylinder, piston, hoses, etc. which are not labeled in FIG. 1 for the purpose of simplicity.

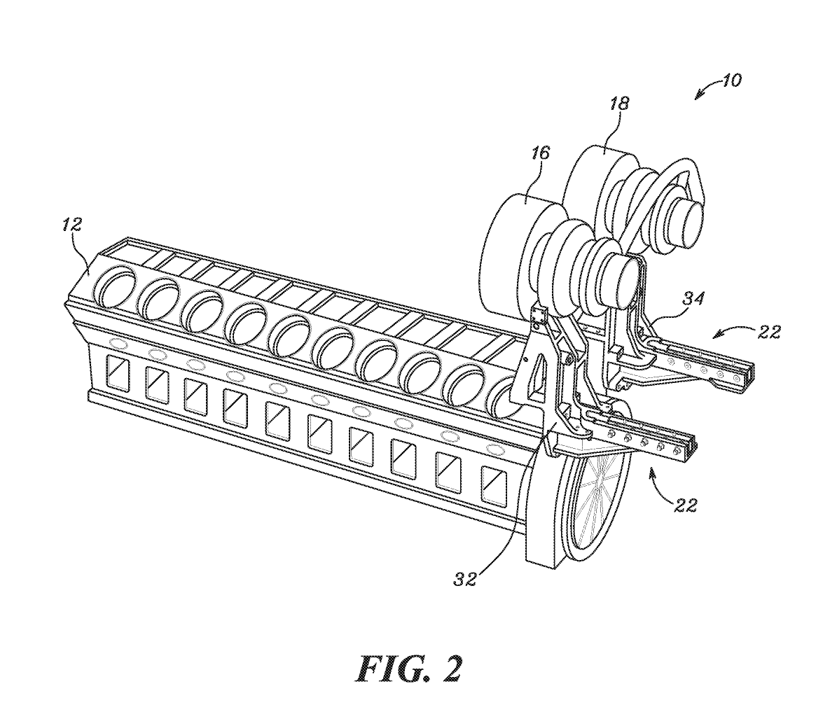

The present disclosure relates to a mounting assembly 22 for connecting the aftercooler 20 to the engine system 10. Referring to FIG. 2, the mounting assembly 22 includes a first mounting assembly 32 and a second mounting assembly 34. The first mounting assembly 32 is coupled to the first turbocharger 16 and the second mounting assembly 34 is coupled to the second turbocharger 18. The first mounting assembly 32 and the second mounting assembly 34 are mounted to the engine block 12 using fasteners, such as bolts, rivets, among others. More specifically, the first mounting assembly 32 and the second mounting assembly 34 are utilized to mount the aftercooler 20 to the engine block 12. The terms “the first mounting assembly 32” and the second mounting assembly 34″ have similar structure, meaning, and interpretation. The description of the first mounting assembly 32 is provided in connection with subsequent figures is also applicable to the second mounting assembly 34 without departing from the meaning and scope of the disclosure. The structure of the first mounting assembly 32 will he described in detail in connection with subsequent figures. Further, although the mounting assembly 22 is shown to include the first and second mounting assemblies 32, 34, in other embodiments, the mounting assembly 22 may include additional assemblies having similar structure to that of the first and second mounting assemblies 32, 34 described herein.

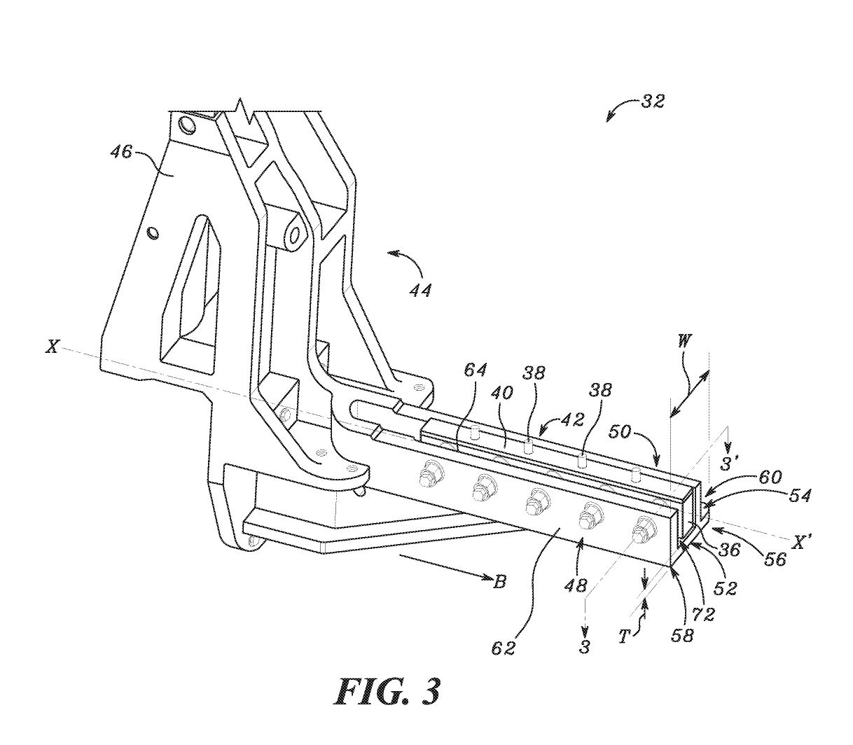

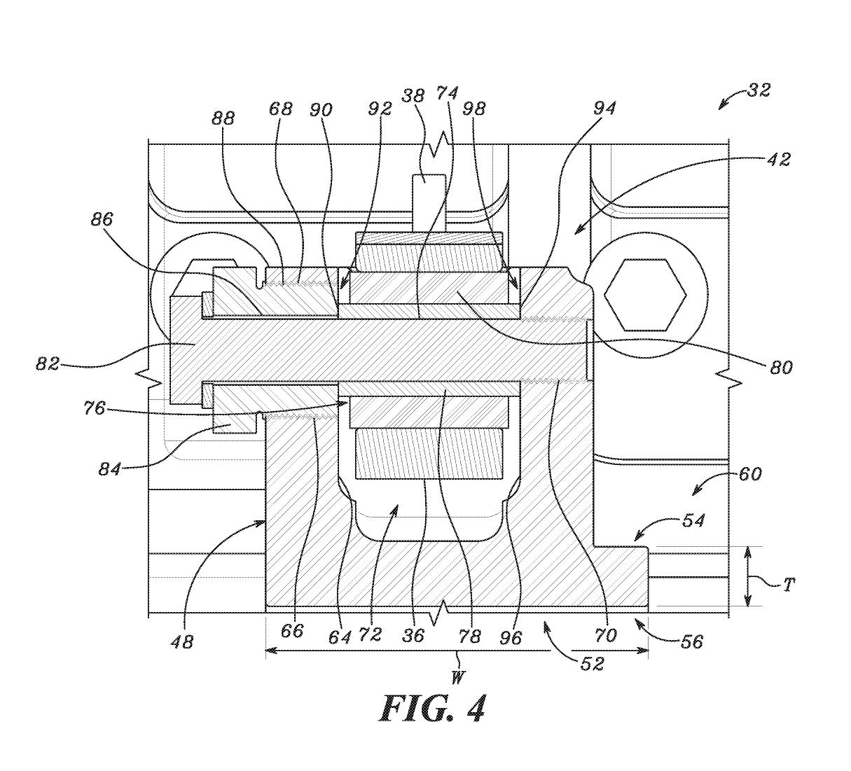

Referring to FIGS. 3 and 4, the first mounting assembly 32 includes a support block 36 for supporting the aftercooler 20 (see FIG. 1) thereon. The support block 36 includes an upper surface 40 having pins 38 thereon, The pins 38 may be dowel pins used to support the aftercooler 20. The first mounting assembly 32 includes a base member 42. The base member 42 extends in a direction B, such that the base member 42 is perpendicular to a support frame 44 connected to the first turbocharger 16 (see FIG. 2). The support frame 44 is integrally connected with the base member 42. The support frame 44 includes a member 46 for providing strength and stability to the support frame 44 of the first mounting assembly 32.

The base member 42 includes a first member 48 and a second member 50 extending therefrom. The base member 42 further includes a flanged portion 52 for supporting the first member 48, and the second member 50. The flanged portion 52 has a first surface 54 and a second surface 56. The first surface 54 is parallel to the second surface 56 defining a thickness T of the flanged portion 52. The flanged portion 52 includes a first end 58 and a second end 60. The distance between the first end 58 and the second end 60 defines a width W of the flanged portion 52. The width W and the thickness T of the flanged portion 52 may vary based on the application.

The first member 48 includes a first surface 62 and a second surface 64 which are parallel with each other and define a thickness of the first member 48 therebetween. The first member 48 includes multiple first through holes 66 see FIG. 4) in a spaced apart arrangement along a first axis X-X′. The first through holes 66 include first threads 68 therein. In an embodiment, the base member 42 has a U shaped cross section. Alternatively, the shape of the base member 42 may vary based on the application. The base member 42 is manufactured from materials, such as steel, or any other suitable material which may withstand loads and shocks. In the accompanying figures, there are five first through holes 66 provided spaced apart from each other. Alternatively, the number of first through holes 66 provided on the first member 48 may vary.

The second member 50 includes multiple second through holes 70 provided in a spaced apart arrangement parallel to the first axis X-X′. In the accompanying figures, there are five second through holes 70 provided spaced apart from each other. Alternatively, the number of second through holes 70 provided on the second member 50 may vary. The multiple first through holes 66 are coaxial with the corresponding multiple second through holes 70.

The support block 36 is adapted to be received into a central cavity 72 defined by the base member 42. The support block 36 is shaped such that dimensions of the support block 36 are smaller than the central cavity 72 of the base member 42 for ensuring that the support block 36 is easily positioned into the central cavity 72. The support block 36 is of a cuboidal shape which has a defined length, width, and height. Alternatively, the shape of the support block 36 may vary based on the application, The support block 36 includes multiple through holes 74. The multiple through holes 74 are provided in a spaced apart arrangement parallel to the first axis X-X′. In the accompanying figures, there are five through holes 74 provided spaced apart from each other. Alternatively, the number of through holes 74 provided on the support block 36 may vary.

Referring to FIG. 4, an isolation assembly 76 is positioned within each of the through holes 74. The isolation assembly 76 includes a sleeve element 78 and an isolation member 80 that are positioned within each of the through holes 74. The sleeve element 78 and the isolation member 80 are disposed in a manner such that central axes of both the sleeve element 78 and the isolation member 80 are coaxially aligned with that of the through holes 74. The isolation member 80 is in a surrounding contacting relationship with the sleeve element 78. The sleeve element 78 is manufactured from metals, such as steel, or any other suitable materials. The isolation member 80 is manufactured from absorbent materials, such as a rubber, or any other suitable materials. The sleeve element 78 is adapted to be in a surrounding contacting relationship with fasteners 82. The through holes 74 of the support block 36 are coaxial with the corresponding first through holes 66 and the second through holes 70 of the base member 42 respectively.

Referring to FIGS. 3 and 4, the support block 36 is positioned within the central cavity 72 of the base member 42 in such a way that the first through holes 66, the through holes 74, and the second through holes 70 are in coaxial alignment with respect to each other. Therefore, the fasteners 82 pass through the first through holes 66, the through holes 74, and the second through holes 70. The fasteners 82 are mechanical fasteners, such as bolts, rivets etc. and may be utilized according to the application. The fasteners 82 may have an integrated washer attached to the head of the fasteners 82. Alternatively, a separate washer may be attached to the fasteners 82 for coupling with the base member 42 according to the application. The support block 36 may use various other components other than the sleeve element 78 and the isolation member 80 based on the application.

Referring to FIG. 4, an adjuster 84 is adapted to be received into each of the first through holes 66 of the first member 48. The adjuster 84 defines a central channel 86 therethrough. The first through holes 66 has the first threads 68 extending from the first surface 62 to the second surface 64 of the first member 48. The central channel 86 of the adjuster 84 is adapted to receive the fastener 82 therein. The adjuster 84 is provided in association with the head of each of the five fasteners 82 (see FIG. 3) used in the mounting assembly 22. The number of adjusters 84 may vary based on the number of fasteners 82 according to the application. In one embodiment, all the fasteners 82 may be provided with the adjuster 84. In other embodiments, at least some of the fasteners 82 may be provided with a corresponding adjuster 84. The adjuster 84 may have any design and shape according to the application. The adjuster 84 is manufactured from materials, such as steel, or any other suitable material. When assembled, second threads 88 of the adjuster 84 are configured to mate with the first threads 68 of the first member 48, when the adjuster 84 is tightened into position. Further, a first surface 88 of the sleeve element 78 of the support block 36 is in a contacting relationship with the adjuster 84 at a first end 92 of the base member 42. A second surface 94 of the sleeve element 78 of the support block 36 is in a contacting relationship with a first surface 96 of the base member 42 at a second end 98 of the base member 42, wherein the first end 92 is opposite the second end

By virtue of contacting relationship, the adjuster 84 may exert a linear force on the first surface 90 of the sleeve element 78, and further this linear force may he transferred to the first surface 96 of the second member 50. This may facilitate clamping the sleeve element 78 within the support block 36. Accordingly, the mounting assembly may reduce or eliminate the vibrations from the aftercooler 20 to transfer to the base member 42. Further the linear force may aid in screw clamping and securing the support block 36 in the central cavity 72.

### INDUSTRIAL APPLICABILITY

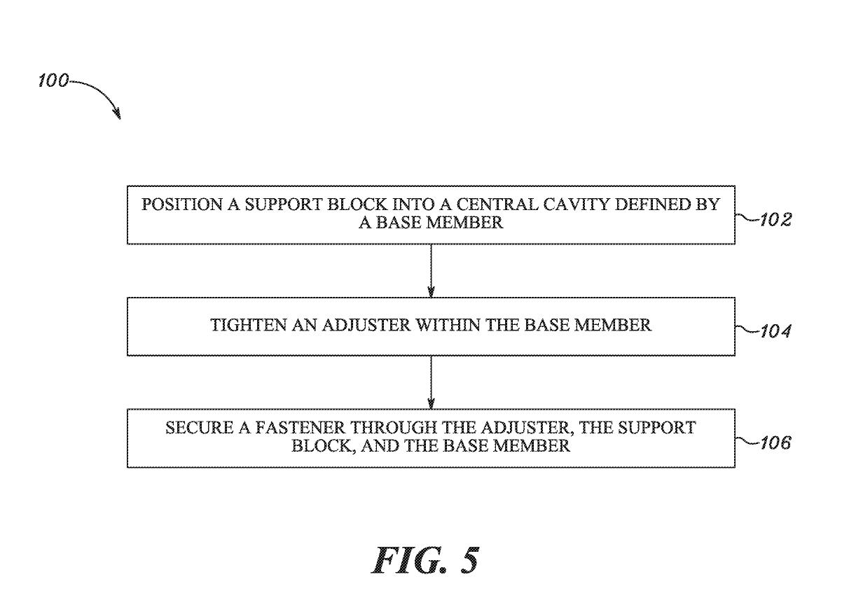

Referring to FIG. 5, a method 100 for coupling the adjuster 84 and the fastener 82 in the first mounting assembly 32 is described, in accordance with the concepts of the present disclosure.

At step 102, the support block 36 is positioned into the central cavity 72 defined by the base member 42. At step 104, the adjuster 84 is tightened within the first member 48. The adjuster 84 includes the second threads 88 adapted to be tightened with the first member 48. At step 106, the fasteners 82 are secured through the adjuster 84, the sleeve element 78 of the support block 36 and the base member 42. More particularly, the fastener 82 is received into the central channel 86 of the adjuster 84, the sleeve element 78 of the support block 36, and the second through hole 70 of the second member 50 of the base member 42 The sleeve element 78 of the support block 36 may be stabilized by the adjuster 84 during installation.

The adjuster 84 of the mounting assembly 22 may reduce or prevent dynamic loading of the respective fasteners 82. The adjuster 84 may maintain preload on the sleeve element 78 which in turn may reduce or prevent dynamic loading of the fasteners 82. In the assembled configuration, the support block 36 may be stabilized by the adjuster 84, leading to longer service life of the aftercooler 20. Further, the adjuster 84 having the second threads 88 for allowing adjustments according to the desired preload. The preload is required to be maintained on the sleeve element 78 as per the requirements. The adjuster 84 may be easily fabricated and hence offers a cost effective solution.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A mounting assembly for connecting an aftercooler to an engine system, the mounting assembly comprising:
a base member including a first member and a second member extending therefrom, the base member having a U shaped cross section, the base member including a plurality of first through holes provided on the first member in a spaced apart arrangement along a first axis, and a plurality of second through holes provided on the second member in a spaced apart arrangement parallel to the first axis, each of the plurality of first through holes being coaxial with the corresponding plurality of second through holes;
an adjuster adapted to be received into each of the plurality of first through holes, the adjuster defining a central channel therethrough, the central channel of the adjuster adapted to receive a fastener therein; and
a support block adapted to be received into a central cavity defined by the base member, the support block including a plurality of through holes, the plurality of through holes provided in a spaced apart arrangement parallel to the first axis, each of the plurality of through holes having an isolation assembly, the isolation assembly including:
a sleeve element, the sleeve element adapted to be in a surrounding contacting relationship with the fastener; and
an isolation member in a surrounding contacting relationship with the sleeve element,
wherein each of the plurality of through holes of the support block is coaxial with the corresponding plurality of first and second through holes of the base member respectively,
wherein a first surface of the sleeve element of the support block is adapted to be in a contacting relationship with the adjuster at a first end of the base member, and a second surface of the sleeve element of the support block is adapted to be in a contacting relationship with a first surface of the base member at a second end of the base member, wherein the first end is opposite to the second end.
